(19) United States
(12) Patent Application Publication
(10) Pub. No.: US 2005/0180813 A1
(43) Pub. Date: Aug. 18, 2005

(54) Method and device for connecting reinforcing steel

(76) Inventor: Hendrik Van De Riet, Hamilton (GB)

Correspondence Address: YOUNG & THOMPSON, 745 SOUTH 23RD STREET, 2ND FLOOR, ARLINGTON, VA, 22202, US

(21) Appl. No.: 10/505,974

(22) PCT Filed: Feb. 27, 2003
(86) PCT No.: PCT/NL03/00150

(30) Foreign Application Priority Data
Feb. 27, 2002 (NL) 1020069

(51) Int. Cl. F16D 1/00

(52) U.S. Cl. 403/307

(57) ABSTRACT

A method for connecting a reinforcing bar to a connecting element comprising a thread-cutting portion which cuts a screw thread on the end of said reinforcing bar. A conical is formed on the end of said reinforcing bar in advance. Said thread-cutting portion cuts a conical screw thread on said conical part.

The invention relates to a method, a connecting element and a system for connecting a reinforcing bar to a connecting element comprising a thread-cutting portion which cuts a screw thread on the end of said reinforcing bar.

Such a method is known from EP-A-0 867 578. Said publication describes a connecting element comprising a hole and a thread-cutting portion disposed at the entrance of said hole. When the connecting element is screwed onto the end of a reinforcing bar, the thread cutting portion cuts an external screw thread on said end, which screw thread is subsequently screwed into the internal screw thread in the aforesaid hole. The connection between the connecting element and the reinforcing bar is effected as a result of the aforesaid external and internal screw threads intermating.

One drawback of this method is inter alia the relatively large number of revolutions which the connecting element must make with respect to the reinforcing bar in order to cut the external screw thread and in order to effect an adequate engagement between the external screw thread being cut and the internal screw thread.

The object of the invention is to provide a method, a connecting element and a system for connecting reinforcing bars by means of which a sufficiently strong connection can ben effected, with relatively few revolutions of the connecting element with respect to the reinforcing bar being required.

In order to accomplish that objective, a conical or tapered part is according to the invention formed on said end in advance, and said thread-cutting portion cuts a conical screw thread on said part. The connection is in that case effected by the mutual engagement of the thread-cutting portion and the conical screw thread being cut. Said engagement appears to suffice for transmitting the forces that occur, whilst in addition a screwed connection which is free from slipping is obtained, so that it is not necessary to set up an additional bias in the screwed connection, so that a torque wrench is no longer necessary.

Since a conical screw thread is used, it is possible, even if the diameter of the reinforcing bar varies, to have the screw thread continue to the location where the conical part of the reinforcing bar begins, i.e. to the location where the reinforcing bar has its full diameter. To that end, the largest diameter of the thread-cutting portion is preferably larger than the diameter of the reinforcing bar whose end is screwed into said portion, so that it is ensured at all times that the reinforcing bar is engaged from the location where the conical part of said end begins. It is not objectionable in that connection if the diameter of the reinforcing bar varies within wide tolerances.

In one preferred embodiment, the connecting element comprises two thread-cutting portions, which are each fitted onto an end of a reinforcing bar, so that two reinforcing bars are interconnected via the connecting element. In this way a simple connecting element for interconnecting two reinforcing bars is obtained, which connecting element is first screwed onto the end of the first reinforcing bar, and into which subsequently the end of the second reinforcing bar is screwed.

In one preferred embodiment, the connecting element comprises two parts which are interconnected after each of said parts has been fitted onto the end of a reinforcing bar, with each of said parts comprising a thread-cutting portion.

Preferably, the two parts of the connecting element are interconnected by a screwed connection after being fitted onto the ends of reinforcing bars. One part may be provided with external screw thread, which is screwed into a hole provided with internal screw thread in the other part. Said internal screw thread may be a cylindrical screw thread but in one preferred embodiment it is a conical screw thread, as a result of which the connection between the two parts can be effected with relatively few revolutions of the parts with respect to each other.

In one preferred embodiment, each of the two parts of the connecting element is provided with a radially extending stop surface. Said stop surfaces may be in contact with each other once the screwed connection has been effected. Preferably, at least one of the parts comprises a portion which is visibly deformed as a result of the screwed connection being tightened. In one preferred embodiment, an annular slot is formed near said stop surfaces, which slot is closed upon tightening of the connection.

In one preferred embodiment, reinforcing bars not having the same diameter can be interconnected in that the two thread-cutting portions cut conical screw threads having mutually different diameters adapted to that of each of the reinforcing bars.

The invention furthermore relates to a connecting element which can be connected to a reinforcing bar, which connecting element comprises a thread-cutting portion capable of cutting a screw thread on the end of said reinforcing bar, with the thread-cutting portion being capable of cutting a conical screw thread on a conical part of the end of said reinforcing bar.

Preferably, the connecting element comprises two parts, which can be interconnected after each of said parts has been fitted onto the end of a reinforcing bar, with each of said parts comprising a thread-cutting portion.

In one preferred embodiment, the two parts can be interconnected by means of a screwed connection, and said screwed connection comprises a conical external screw thread and a corresponding conical internal screw thread.

Preferably, at least one of said parts comprises a portion which is visibly deformed as a result of the screwed connection being tightened.

The invention furthermore relates to a system comprising a reinforcing bar and a connecting element comprising a thread-cutting portion capable of cutting a screw thread on the end of the reinforcing bar, in which the thread-cutting portion is capable of cutting a conical screw thread on a conical part of the end of said reinforcing bar.

In one preferred embodiment, the system comprises two reinforcing bars, with the connecting element comprising two thread-cutting portions, which can each be fitted onto an end of a reinforcing bar, so that the two reinforcing bars can be interconnected via the connecting element.

In one preferred embodiment, the two reinforcing bars do not have the same diameter, and the two thread-cutting portions cut mutually different screw threads.

Hereinafter are a few embodiments of the invention will be described with reference to the drawing by way of explanation of the invention.

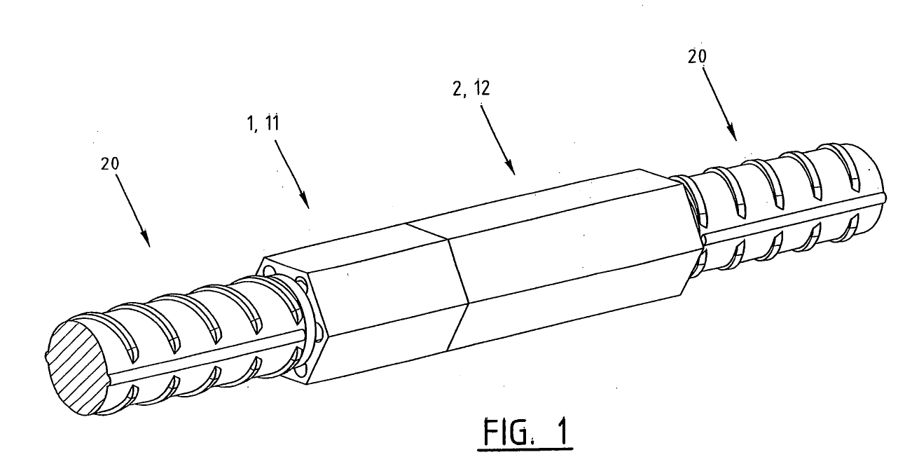

FIG. 1 shows the first part of a first embodiment of a connecting element;

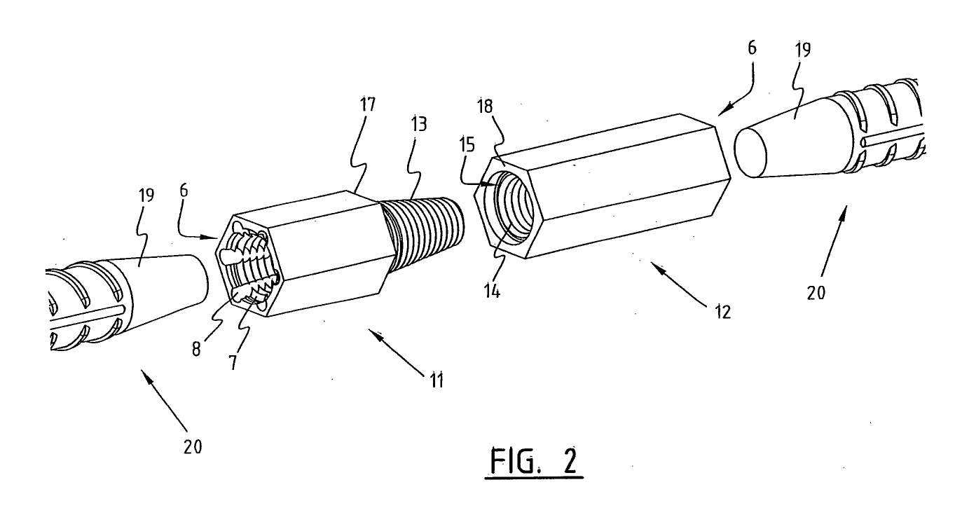

FIG. 2 shows the second part of said first embodiment;

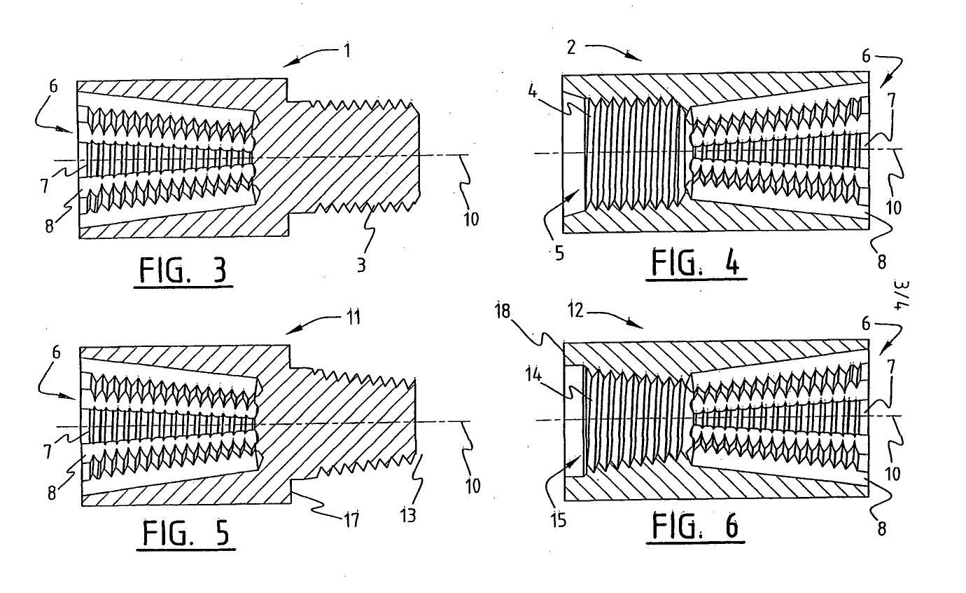

FIG. 3 shows the first part of the second embodiment of a connecting element;

FIG. 4 shows the second part of said second embodiment;

FIG. 5 is a side elevation of each of the FIGS. 1-4; and

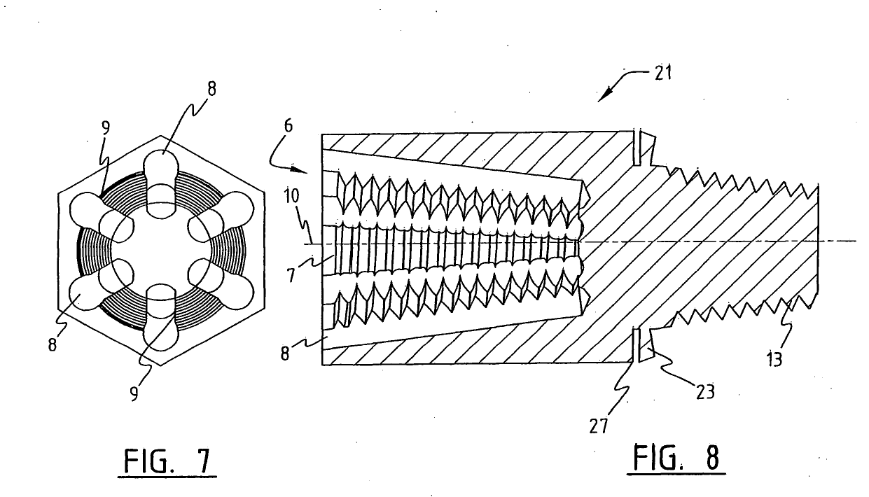

FIG. 6 shows a part of a third embodiment of a connecting element.

The figures are merely diagrammatically representations of the embodiments.

FIGS. 1 and 2 show a connecting element consisting of a first part 1 (FIG. 1) and a second part 2 (FIG. 2). The two parts 1, 2 can be interconnected by means of a screwed connection consisting of an external screw thread 3 on part 1 and an internal screw thread 4 in the hole 5 present in part 2.

FIGS. 3 and 4 show a connecting element consisting of a first part 11 (FIG. 3) and a second part 12 (FIG. 4). Also these two parts 11, 12 can be interconnected, to which end the first part 11 is provided with an external screw thread 13 and the second part 12 is provided with an internal screw thread 34 in the hole 15.

In the first embodiment (FIGS. 1 and 2) the two parts 1, 2 of the connecting element are interconnected by means of a cylindrical screwed connection 3, 4, and in the second embodiment a conical screwed connection 13, 14 is used, as appears from the figures. One advantage of using a conical screwed connection is the fact that fewer revolutions of the two parts 1, 2; 11, 12 with respect to each other are required for effecting the connection.

On the left-hand side of FIGS. 1 and 3 (parts 1 and 11) and/or the right-hand side of FIGS. 2 and 4 (parts 2 and 12) a conical hole 6 is shown, which is provided with a conical screw thread 7. Said conical screw thread is interrupted at 6 circumferentially distributed positions by a recess 8, so that cutting edges 9 (FIG. 5) are formed, which are capable of cutting a conical screw thread on a conical end of a reinforcing bar. The reinforcing bar is not shown in the figures.

FIG. 5 schematically shows the hole 6 in side elevation (seen in axial direction), showing the six recesses 8 and the cutting edges 9 formed thereby. The recesses 8 are each substantially cylindrical in shape, with the central axis thereof extending at an angle to the central axis 10 of the connecting element 1, 2; 11, 12.

From FIG. 5 it furthermore appears that the outer circumference of the connecting element as shown in the embodiments is hexagonal, so that the two parts 1, 11 and 2, 12 can each be screwed onto an end of a reinforcing bar, using a spanner, after which they can be screwed together, which may be done by means of a torque wrench. In particular in the case of larger diameters it is also possible to use a circular (cylindrical) outer circumference, which leads to a smaller diameter.

Before the part 1, 2; 11, 12 in question is fitted onto the end of a reinforcing bar, said end is subjected to a machining operation, for example a metal removing operation, so as to make said end taper, i.e. to give it the shape of a truncated cone, with the apex thereof being present at the end of the reinforcing bar. The apex angle of the cone corresponds to the angle of the taper of the conical hole 6.

When the end of the reinforcing bar is screwed into the hole 6, a screw thread will be cut along the entire length of the conical end, or a large part thereof, during which operation the metal cuttings can accumulate in the recesses 8. The internal conical screw thread 7 in the hole 6, which also functions as a cutting tool (cutting edges 9) will come into engagement with the end of the reinforcing bar along the aforesaid length, resulting in an adequate fixation of the reinforcing bar in the connecting element 1, 2, 11, 12 after a few revolutions, when a sufficient width of screw thread has been formed.

The number of revolutions required for cutting the conical screw thread intera alia depends on the shape and the dimension of the conical screw thread and on the aforesaid apex angle. Satisfactory results have been obtained with an apex angle of about 12 degrees and a dimension of the screw thread such that four to five revolutions are required for cutting the screw thread.

In the second embodiment, which is shown in FIGS. 3 and 4, the part 11 of the connecting element is provided with a radially extending stop surface 17, which can mate with the stop surfaces 18 of the part 12 in the situation in which the two parts 11, 12 are screwed together. As a result of the force with which the stop surfaces 17, 18 are pressed together, a bias is set up in the screwed connection 13, 14, which bias helps to effect a firm connection without the need of a torque wrench.

FIG. 6 shows a part 21 of a connecting element according to a third embodiment, which part 21 substantially corresponds to the part 11 (FIG. 3) of the second embodiment. The difference with the second embodiment is the presence of a deformable portion 23, which is pressed against the stop surface 17 when the screwed connection between the two parts of the connecting element is tightened with a sufficiently large moment. This makes it possible to establish visually that an adequate interconnection has been obtained and that there is no need for a torque wrench.

The embodiments as described above are merely examples of a connecting element, of which a great many variants are possible.

1. A method for connecting a reinforcing bar to a connecting element comprising a thread-cutting portion (7,8) which cuts a screw thread on the end of said reinforcing bar, characterized in that a conical part is formed on said end in advance, and in that said thread-cutting portion (7,8) cuts a conical screw thread on said part.

2. A method according to claim 1, characterized in that the largest diameter of the thread-cutting portion (7,8) is larger than the diameter of the reinforcing bar whose end is screwed into said portion (7,8).

3. A method according to claim 1, characterized in that the connecting element (1,2; 11,12) comprises two thread-cutting portions (7,8), which are each fitted onto an end of a reinforcing bar, so that two reinforcing bars are interconnected via the connecting element.

4. A method according to claim 3, characterized in that the connecting element (1,2; 11,12) comprises two parts which are interconnected after each of said parts has been fitted onto the end of a reinforcing bar, with each of said parts comprising a thread-cutting portion (7,8).

5. A method according to claim 4, characterized in that said two parts (1, 11; 2,12) are interconnected by a screwed connection (3,4; 13,14).

6. A method according to claim 5, characterized in that said screwed connection comprises a conical external screw thread (13) and a corresponding conical internal screw thread (14).

7. A method according to claim 5, characterized in that each of the two parts (1,2; 11, 12) of the connecting element is provided with a radially extending stop surface (17,18), which stop surfaces (17,18) will be in contact with each other once the screwed connection has been effected.

8. A method according to claim 5, characterized in that at least one of said parts (1, 2; 11,12) comprises a portion (23) which is visibly deformed as a result of the screwed connection being tightened.

9. A method according to claim 3, characterized in that reinforcing bars not having the same diameter are interconnected.

10. A connecting element which can be connected to a reinforcing bar, which connecting element (1,2; 11,12) comprises a thread-cutting portion (7,8) capable of cutting a screw thread on the end of said reinforcing bar, characterized in that the thread-cutting portion (7,8) is capable of cutting a conical screw thread on a conical part of the end of said reinforcing bar.

11. A connecting element according to claim 10, characterized in that the connecting element (1,2; 11, 12) comprises two thread-cutting portions (7,8), which can each be fitted onto an end of a reinforcing bar, so that two reinforcing bars are interconnected via said connecting element (1, 2; 11,12).

12. A connecting element according to claim 1, characterized in that the connecting element (1, 2; 11,12) comprises two parts, which can be interconnected after each of said parts (1,2; 11,12) has been fitted onto the end of a reinforcing bar, with each of said parts comprising a thread-cutting portion (7,8).

13. A connecting element according to claim 12, characterized in that the two parts (1,2; 11,12) can be interconnected by means of a screwed connection (3, 4; 13,14).

14. A connecting element according to claim 13, characterized in that said screwed connection comprises a conical external screw thread (13) and a corresponding conical internal screw thread (14).

15. A connecting element according to claim 13, characterized in that each of the two parts (1,2; 11,12) of the connecting element (1,2; 11,12) is provided with a radially extending stop surface (17, 18), which stop surfaces will be in contact with each other once the screwed connection (3,4 13,14) has been effected.

16. A connecting element according to claim 13, characterized in that at least one of said parts (1,2; 11,12) comprises a portion (23) which is visibly deformed as a result of the screwed connection (3,4; 13,14) being tightened.

17. A connecting element according to claim 13, characterized in that the two thread-cutting portions (7,8) are capable of cutting mutually different screw threads.

18. A system comprising a reinforcing bar and a connecting element (1,2; 11,12) comprising a thread-cutting portion (7,8) capable of cutting a screw thread on the end of the reinforcing bar, characterized in that the thread-cutting portion (7,8) is capable of cutting a conical screw thread on a conical part of the end of said reinforcing bar.

19. A system according to claim 18, characterized in that the two reinforcing bars do not have the same diameter, and in that the thread-cutting portions (7,8) cut mutually different screw threads.

20. A method according to claim 2, characterized in that the connecting element (1,2; 11,12) comprises two thread-cutting portions (7,8), which are each fitted onto an end of a reinforcing bar, so that two reinforcing bars are interconnected via the connecting element.
